(19) United States
(12) Patent Application Publication
(10) Pub. No.: US 2013/0162763 A1
(43) Pub. Date: Jun. 27, 2013

(54) METHOD AND APPARATUS FOR ADJUSTING DEPTH-RELATED INFORMATION MAP ACCORDING TO QUALITY MEASUREMENT RESULT OF THE DEPTH-RELATED INFORMATION MAP

(71) Applicant: Chao-Chung Cheng, Tainan City (TW)

(72) Inventor: Chao-Chung Cheng, Tainan City (TW)

(21) Appl. No.: 13/570,256

(22) Filed: Aug. 9, 2012

Related U.S. Application Data
(60) Provisional application No. 61/579,669, filed on Dec. 23, 2011.

(51) Int. Cl. H04N 13/00

(52) U.S. Cl. 348/42; 348/E13.067

(57) ABSTRACT

An exemplary depth control method includes following steps: receiving input images corresponding to different views; generating at least one depth-related information map according to the input images; estimating a confidence level by measuring quality of the depth-related information map; and adjusting the depth-related information map according to the confidence level. In addition, an exemplary depth control apparatus includes a depth-related information map generation circuit, a quality measurement circuit and an adjustment circuit. The depth-related information map generation circuit receives input images corresponding to different views, and generates at least one depth-related information map according to the input images. The quality measurement circuit estimates a confidence level by measuring quality of the depth-related information map. The adjustment circuit adjusts the depth-related information map according to the confidence level. Then the depth-related information maps are used by an image interpolation unit to interpolate output images.

### CROSS REFERENCE TO RELATED APPLICATIONS

This application claims the benefit of U.S. provisional application No. 61/579,669, filed on Dec. 23, 2011 and incorporated herein by reference.

### BACKGROUND

The disclosed embodiments of the present invention relate to stereoscopic display, and more particularly, to a depth control method for adjusting a depth-related information map (e.g., a disparity map or a depth map) according to a quality measurement result of the depth-related information map, and related depth control apparatus and machine readable medium thereof.

With the development of science and technology, users are pursing stereoscopic and more real image display rather than high quality images. There are two techniques of present stereo display. One is to use a video display apparatus, which collaborates with glasses (such as anaglyph glasses, polarization glasses or shutter glasses), while the other is to use only a video display apparatus without any accompanying glasses. No matter which technique is utilized, the main theory of stereo display is to make the left eye and the right eye see different images, thus viewer's brain will regard the different images seen from two eyes as a stereo image.

Regarding the general two-dimensional (2D) display, the focal distance/plane is the same as the convergence distance/plane. However, regarding the three-dimensional (3D) display, the focal plane is on the display screen, but the convergence plane may be misaligned with the focal plane. An improper mismatch may introduce uncomfortable stereo feeing for the viewer. For example, the viewer may have uncomfortable stereo feeing when a displayed 3D object is too far or too near. Besides, the viewer may also have uncomfortable stereo feeing when a 3D object is displayed with too less stereo effect or too much stereo effect.

Thus, to improve the stereo display quality, there is a need for an adaptive depth adjustment which is capable of dynamically changing the depth/disparity setting of the images to be displayed under a 3D display environment.

### SUMMARY

In accordance with exemplary embodiments of the present invention, a depth control method for adjusting a depth-related information map (e.g., a disparity map or a depth map) according to a quality measurement result of the depth-related information map, and related depth control apparatus and machine readable medium thereof are proposed, to solve the above-mentioned problems.

According to a first aspect of the present invention, an exemplary depth control method is disclosed. The exemplary depth control method includes: receiving a plurality of input images corresponding to different views; generating at least one depth-related information map according to the input images; estimating a confidence level by measuring quality of the at least one depth-related information map; and adjusting the at least one depth-related information map according to the confidence level.

According to a second aspect of the present invention, an exemplary depth control apparatus is disclosed. The exemplary depth control apparatus includes a depth-related information map generation circuit, a quality measurement circuit and an adjustment circuit. The depth-related information map generation circuit is arranged for receiving a plurality of input images corresponding to different views, and generating at least one depth-related information map according to the input images. The quality measurement circuit is arranged for estimating a confidence level by measuring quality of the at least one depth-related information map. The adjustment circuit is arranged for adjusting the at least one depth-related information map according to the confidence level.

According to a third aspect of the present invention, an exemplary machine readable medium is disclosed. The exemplary machine readable medium is arranged for storing a program code which causes a processor to perform following steps when executed by the processor: receiving a plurality of input images corresponding to different views; generating at least one depth-related information map according to the input images; estimating a confidence level by measuring quality of the at least one depth-related information map; and adjusting the at least one depth-related information map according to the confidence level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a depth control apparatus according to a first embodiment of the present invention.

FIG. 2 is a block diagram illustrating a first exemplary implementation of a quality measurement circuit according to the present invention.

FIG. 3 is a diagram illustrating an example of the confidence level determination performed by the quality measurement circuit shown in FIG. 2.

FIG. 4 is a block diagram illustrating a second exemplary implementation of a quality measurement circuit according to the present invention.

FIG. 5 is a diagram illustrating an example of the confidence level determination performed by the quality measurement circuit shown in FIG. 4.

FIG. 6 a diagram illustrating a first exemplary implementation of an adjustment circuit according to the present invention.

FIG. 7 is a diagram illustrating a second exemplary implementation of an adjustment circuit according to the present invention.

FIG. 8 is a diagram illustrating the exemplary mapping relationship between a confidence level and a second depth control weighting factor (e.g., a local weighting factor).

FIG. 9 is a diagram illustrating the exemplary relationship among original depth-related values, local depth-related values, and a global depth-related value.

FIG. 10 is a flowchart illustrating a depth control method according to an embodiment of the present invention.

FIG. 11 is a block diagram illustrating a depth control apparatus according to a second embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

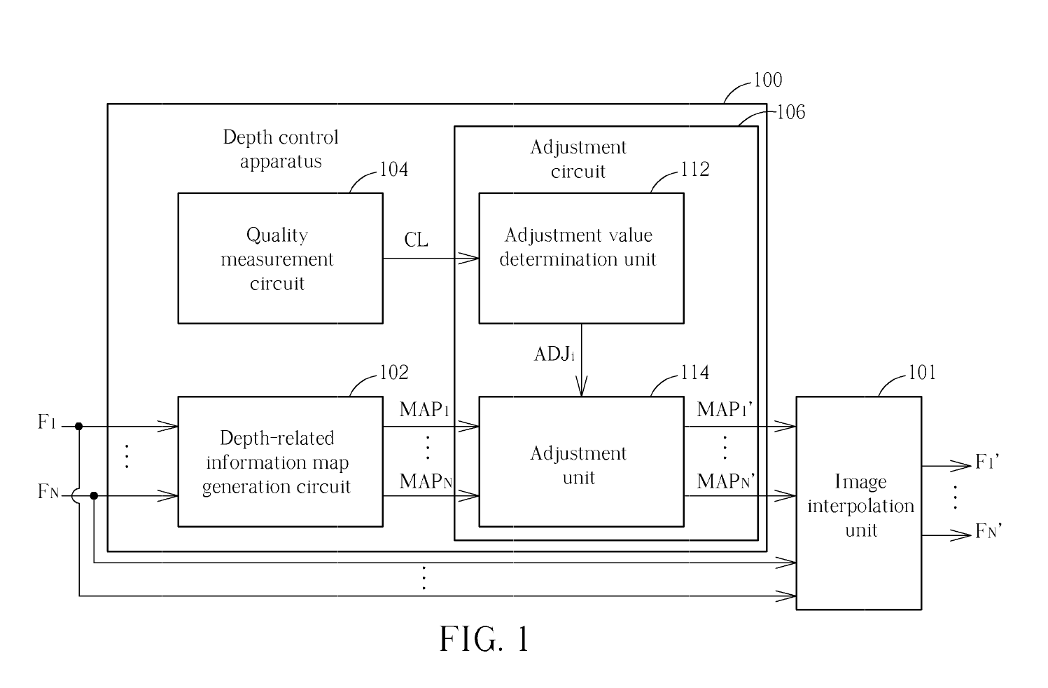

FIG. 1 is a block diagram illustrating a depth control apparatus according to a first embodiment of the present invention. The depth control apparatus includes a depth-related information map generation circuit 102, a quality measurement circuit 104, and an adjustment circuit 106, where the adjustment circuit 106 includes an adjustment value determination unit 112 and an adjustment unit 114. The depth-related information map generation circuit 102 is arranged for receiving a plurality of input images F₁-F_{N} corresponding to different views, and generating one or more depth-related information maps (e.g., disparity maps or depth maps) MAP₁-MAP_{N} according to the input images F₁-F_{N}. For example, the input images F₁-F_{N} may include a left-view image and a right-view image paired with each other, and the depth-related information maps MAP₁-MAP_{N} may include one disparity map generated for the left-view image and another disparity map generated for the right-view image.

Alternatively, the input images F₁-F_{N} are derived from a multi-view video stream, and one disparity information map may be generated for two input images with adjacent viewing angles. The quality measurement circuit 104 is arranged for estimating a confidence level CL by measuring quality of depth-related information map(s) generated from the depth-related information map generation circuit 102. In other words, the confidence level CL is indicative of the quality of estimated disparity/depth map(s). The adjustment circuit 106 is coupled to the depth-related information map generation circuit 102, the quality measurement circuit 104 and an image interpolation unit 101, and is arranged for adjusting the depth-related information maps MAP₁-MAP_{N} according to the confidence level CL, and accordingly outputting adjusted depth-related information maps (e.g., adjusted disparity maps or adjusted depth maps) MAP₁′-MAP_{N}′ to the image interpolation unit 101.

More specifically, the adjustment value determination unit 112 of the adjustment circuit 106 is arranged for determining an adjustment value ADJᵢ for each depth-related value included in a depth-related information map (e.g., one of MAP₁-MAP_{N}) according to the confidence level CL, and the adjustment unit 114 of the adjustment circuit 106 is arranged for applying adjustment values ADJᵢ to respective depth-related values included in the depth-related information map (e.g., one of MAP₁-MAP_{N}). The image interpolation unit 101 generates output images F₁′-F_{N}′ corresponding to different views by performing interpolation upon the input images F₁-F_{N} according to the adjusted depth-related information maps MAP₁′-MAP_{N}′. In other words, based on the adjusted depth-related information maps MAP₁′-MAP_{N}′ provided by the depth control apparatus 100, the image interpolation unit 101 is arranged to adjust the depth effect of the input images F₁-F_{N} (e.g., stereo effect of the input images F₁-F_{N}) to thereby interpolate resultant output images F₁′-F_{N}′ with adjusted views. Hence, when the output images F₁′-F_{N}′ are displayed, the viewer will have improved 3D viewing experience due to adaptive depth adjustment.

To put it simply, the adjustment made to the depth-related information maps will result in adjusted depth effect due to the fact that the output images are derived from the input images and the adjusted depth-related information maps. Thus, the adaptive depth control applied to the input images F₁-F_{N} to be displayed is achieved by adjusting at least a portion (e.g., part or all) of the originally generated depth-related information maps MAP₁-MAP_{N}. With proper adjustment made to the depth-related information maps MAP₁-MAP_{N}, the input images F₁-F_{N} are adequately adjusted to make the resultant output images F₁′-F_{N}′ provide the viewer with comfortable 3D feeling. As the present invention focuses on the adaptive depth adjustment performed by the depth control apparatus 100, further description of the image interpolation unit 101 is omitted here for brevity.

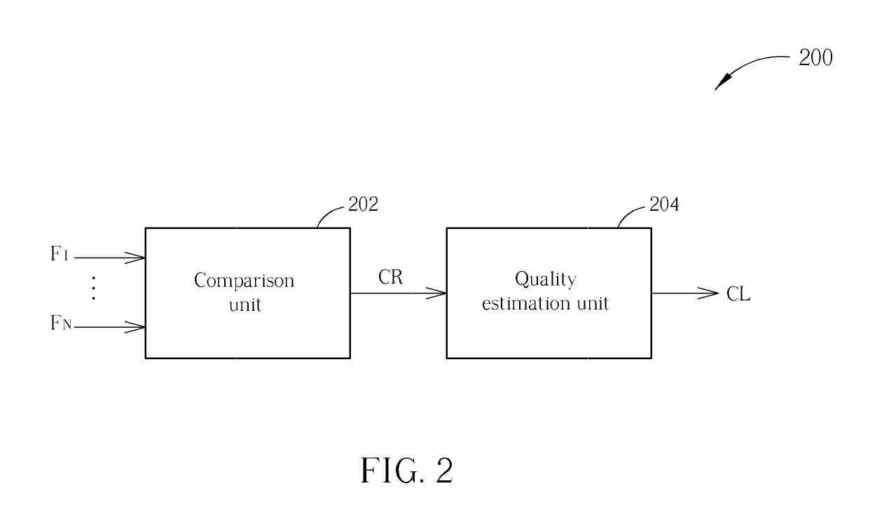

As mentioned above, the quality measurement circuit 104 is responsible for generating the confidence level CL indicative of the quality of the estimated disparity/depth maps. Please refer to FIG. 2, which is a block diagram illustrating a first exemplary implementation of a quality measurement circuit according to the present invention. In one embodiment, the quality measurement circuit 104 shown in FIG. 1 may be realized by the quality measurement circuit 200 shown in FIG. 2. The quality measurement circuit 200 includes a comparison unit 202 and a quality estimation unit 204. The comparison unit 202 is arranged for performing a comparison upon images selected from the input images F₁-F_{N}, and accordingly generating a comparison result CR. The quality estimation unit 204 is coupled to the comparison unit 202, and arranged for estimating the confidence level CL by referring to the comparison result CR.

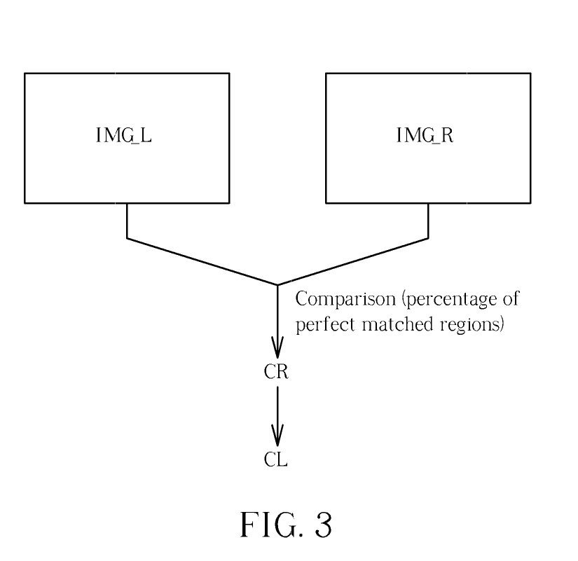

An example of the confidence level determination performed by the quality measurement circuit 200 is illustrated in FIG. 3. Consider a case where the input images F₁-F_{N} include a pair of a left-view image IMG_L and a right-view image IMG_R. The comparison unit 202 is therefore operative to check the percentage of perfect matched regions found in the left-view image IMG_L and the right-view image IMG_R by comparing pixel values of the left-view image and the right-view image, and then generate the comparison result CR indicative of the percentage of perfect matched regions. When the percentage of perfect matched regions is low, this implies that there is a large occlusion region or there are many occlusion regions or unmatched regions. That is, the disparity/depth estimation is unreliable. Next, the quality estimation unit 204 refers to the percentage of perfect matched regions (i.e., the comparison result CR) to set the confidence level CL. By way of example, the confidence level CL may be positively correlated with the percentage of perfect matched regions. In other words, the confidence level CL would be set by a larger value when the percentage of perfect matched regions is higher, and the confidence level CL would be set by a smaller value when the percentage of perfect matched regions is lower.

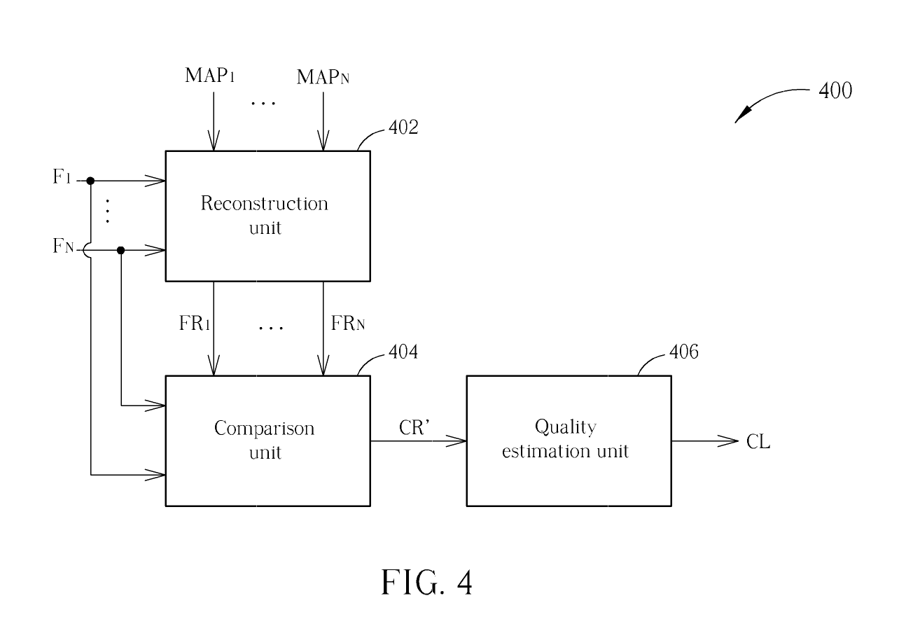

Please refer to FIG. 4, which is a block diagram illustrating a second exemplary implementation of a quality measurement circuit according to the present invention. In another embodiment, the quality measurement circuit 104 shown in FIG. 1 may be realized by the quality measurement circuit 400 shown in FIG. 4. The quality measurement circuit 400 includes a reconstruction unit 402, a comparison unit 404 and a quality estimation unit 406. The reconstruction unit 402 is arranged for generating at least one reconstructed image FR₁-FR_{N} according to at least one depth-related information map MAP₁-MAP_{N} and at least one image selected from the input images F₁-F_{N}. The comparison unit 404 is coupled to the reconstruction unit 402, and arranged for performing a comparison upon at least one reconstructed image FR₁-FR_{N} and at least one image selected from the input images F₁-F_{N}, and accordingly generating a comparison result CR′. The quality estimation unit 406 is coupled to the comparison unit 404, and arranged for estimating the confidence level CL by referring to the comparison result CR′.

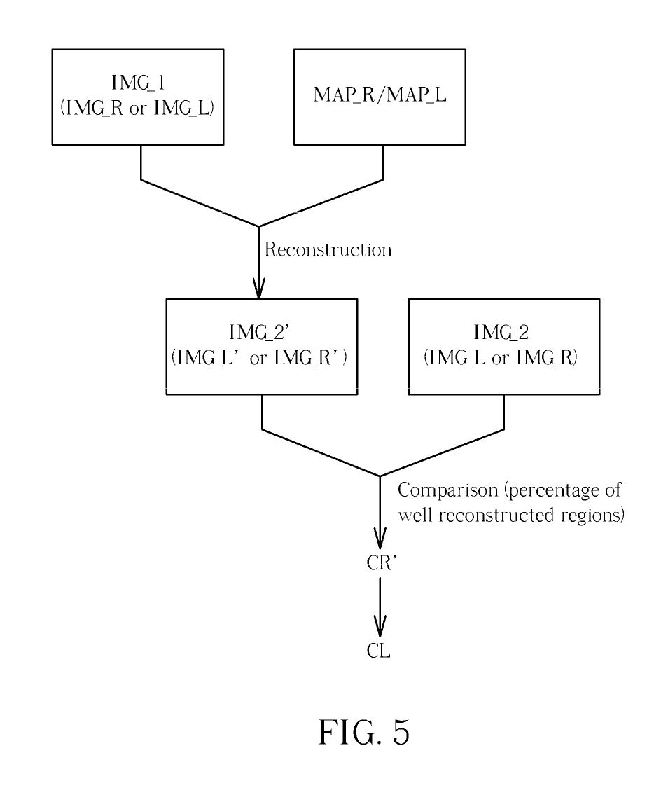

An example of the confidence level determination performed by the quality measurement circuit 400 is illustrated in FIG. 5. Consider a case where the input images F₁-F_{N} include a pair of a left-view image IMG_L and a right-view image IMG_R, where one of the input images IMG_1 and IMG_2 shown in FIG. 5 is the left-view image IMG_L, and the other of the input images IMG_1 and IMG_2 shown in FIG. 5 is the right-view image IMG_R. When the input image IMG_1 is the left-view image IMG_L, the reconstruction unit 402 generates a reconstructed image IMG_2′ (e.g., a reconstructed right-view image IMG_R′) according to the left-view image IMG_L and the corresponding disparity/depth map MAP_L of the left-view image IMG_L, and the comparison unit 404 checks the percentage of well reconstructed regions found in the original input image IMG_2 (i.e., the right-view image IMG_R) and the reconstructed image IMG_2′ (i.e., the reconstructed right-view image IMG_R′) by comparing pixel values of the original right-view image and the reconstructed right-view image, and generates the comparison result CR′ indicative of the percentage of well reconstructed regions. When the percentage of well reconstructed regions is low, this implies that there is a large occlusion region or there are many occlusion regions. That is, the disparity/depth estimation is unreliable. Next, the quality estimation unit 406 refers to the percentage of well reconstructed regions (i.e., the comparison result CR′) to set the confidence level CL. By way of example, the confidence level CL may be positively correlated with the percentage of well reconstructed regions. In other words, the confidence level CL would be set by a larger value when the percentage of well reconstructed regions is higher, and the confidence level CL would be set by a smaller value when the percentage of well reconstructed regions is lower.

When the input image IMG_1 is the right-view image IMG_R, the reconstruction unit 402 generates a reconstructed image IMG_2′ (e.g., a reconstructed left-view image IMG_L′) according to the right-view image IMG_R and the disparity/depth map MAP_R of the right-view image IMG_R, and the comparison unit 404 checks the percentage of well reconstructed regions found in the original input image IMG_2 (i.e., the left-view image IMG_L) and the reconstructed image IMG_2′ (i.e., the reconstructed left-view image IMG_L′) by comparing pixel values of the original right-view image and the reconstructed right-view image, and generates the comparison result CR′ indicative of the percentage of well reconstructed regions. Next, the quality estimation unit 406 refers to the percentage of well reconstructed regions (i.e., the comparison result CR′) to set the confidence level CL. The same objective of setting the confidence level CL in response to the percentage of well reconstructed regions is achieved.

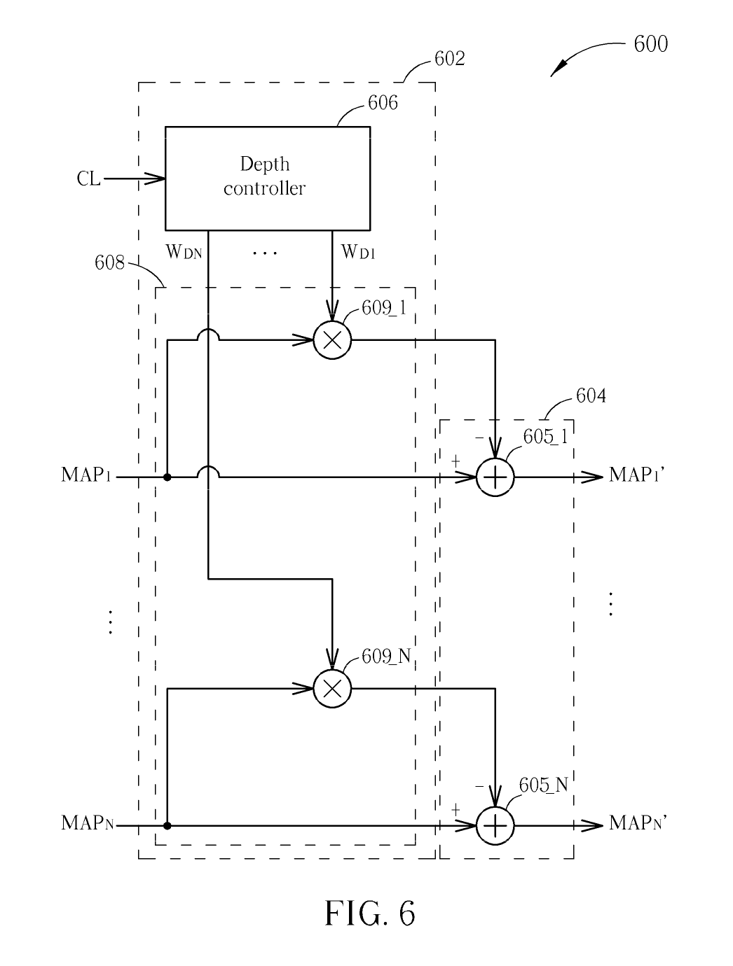

After receiving the confidence level CL provided by the quality measurement circuit, the adjustment circuit 106 refers to the received confidence level CL to apply adaptive depth adjustment to the depth-related information maps MAP₁-MAP_{N} for achieving the objective of making adaptive depth control to the input images F₁-F_{N} to be displayed. Please refer to FIG. 6, which is a diagram illustrating a first exemplary implementation of an adjustment circuit according to the present invention. In one embodiment, the adjustment circuit 106 shown in FIG. 1 may be realized by the adjustment circuit 600 shown in FIG. 6. The adjustment circuit 600 includes an adjustment value determination unit 602 and an adjustment unit 604, where the adjustment value determination unit 112 and the adjustment unit 114 shown in FIG. 1 may be realized by the adjustment value determination unit 602 and the adjustment unit 604, respectively.

In this embodiment, the adjustment value determination unit 602 includes a depth controller 606 and an adjustment value determinator 608. The depth controller 606 is arranged for setting a plurality of depth control weighting factors W_{D1}-W_{DN} for different depth-related information maps (e.g., disparity maps or depth maps) MAP₁-MAP_{N} in response to the confidence level CL. In one exemplary design, the depth control weighting factors W_{D1}-W_{DN} may be identical to each other. That is, the depth controller 606 may use the same value to set the depth control weighting factors W_{D1}-W_{DN}. In another exemplary design, some or all of the depth control weighting factors W_{D1}-W_{DN} may be different from each other. That is, the depth controller 606 may set values of the depth control weighting factors W_{D1}-W_{DN}, individually. Regarding each of the depth control weighting factors W_{D1}-W_{DN}, the depth control weighting factor may be positively correlated with the confidence level CL. For example, the depth control weighting factor would be set by a larger value when the confidence level CL is higher, and the depth control weighting factor would be set by a smaller value when the confidence level CL is lower.

The adjustment value determinator 608 is coupled to the depth controller 606, and includes a plurality of multipliers 609_1-609_N. The multipliers 609_1-609_N receive the depth control weighting factors W_{D1}-W_{DN}, respectively. Each multiplier is arranged for multiplying a corresponding depth control weighting factor and each depth-related value (e.g., a disparity value or a depth value) included in a corresponding depth-related information map. In other words, the adjustment value determinator 608 is a pixel-based processing circuit used to determine an adjustment value for each depth-related value.

Regarding the adjustment unit 604, it is coupled to the adjustment value determinator 608, and includes a plurality of adders 605_1-605_N, each arranged for perform a subtraction operation upon adjustment values and respective depth-related values of one depth-related information map to thereby generate one adjusted depth-related information map having adjusted depth-related values included therein. In this way, the adjustment unit 604 outputs the adjusted depth-related information maps MAP₁′-MAP_{N}′ with the desired disparity/depth setting. Thus, the following image interpolation unit 101 can refer to the adjusted depth-related information maps MAP₁′-MAP_{N}′ to perform depth control upon the input images F₁-F_{N} and accordingly generate the output images F₁′-F_{N}′ with an adjusted depth effect. The pixel-based operation of the adjustment circuit 600 may be expressed using the following equation.

D_{Adjusted}=D_{Estimated}−α·D_{Estimated} (1)

In above equation (1), D_{Adjusted} represents the adjusted disparity/depth value included in an adjusted disparity/depth map, D_{Estimated} represents the original disparity/depth value included in an estimated disparity/depth map, α·D_{Estimated} represents the adjustment value, and α represent the depth control weighting factor. It should be noted that the same depth control weighting factor is applied to all of the disparity/depth values included in the same estimated disparity/depth map.

When there is a large occlusion region (or there are many occlusion regions) and/or the reliability of the estimated disparity/depth map is poor, the depth control weighting factor would be reduced to mitigate the undesired side effect, thus allowing the 3D display to be adjusted to a comfortable convergence depth. In this way, the 3D display quality is improved.

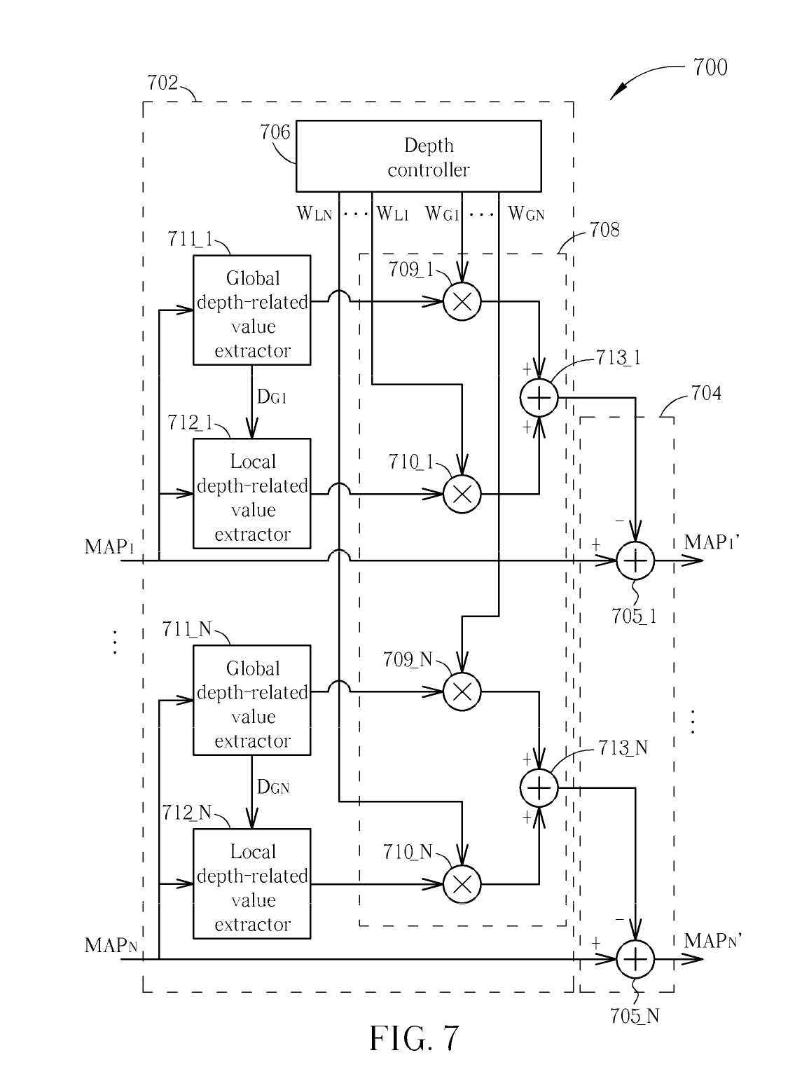

Please refer to FIG. 7, which is a diagram illustrating a second exemplary implementation of an adjustment circuit according to the present invention. In another embodiment, the adjustment circuit 106 shown in FIG. 1 may be realized by the adjustment circuit 700 shown in FIG. 7. The adjustment circuit 700 includes an adjustment value determination unit 702 and an adjustment unit 704, where the adjustment value determination unit 112 and the adjustment unit 114 shown in FIG. 1 may be realized by the adjustment value determination unit 702 and the adjustment unit 704, respectively. In this embodiment, the adjustment value determination unit 702 includes a depth controller 706, an adjustment value determinator 708, a plurality of global depth-related value extractors 711_1-711_N, and a plurality of local depth-related value extractors 712_1-712_N. The depth controller 706 is arranged for setting a plurality of first depth control weighting factors W_{G1}-W_{GN} for different depth-related information maps (e.g., disparity maps or depth maps) MAP₁-MAP_{N} and further arranged for setting a plurality of second depth control weighting factors W_{L1}-W_{LN} for different depth-related information maps (e.g., disparity maps or depth maps) MAP₁-MAP_{N}.

In this embodiment, the second depth control weighting factors W_{L1}-W_{LN} may be dynamically set in response to the confidence level CL, and first depth control weighting factors W_{G1}-W_{GN} may be kept unchanged each time determination of the adjustment value for each depth-related value is performed. Alternatively, the first depth control weighting factors W_{G1}-W_{GN} and the second depth control weighting factors W_{L1}-W_{LN} may be adjusted separately.

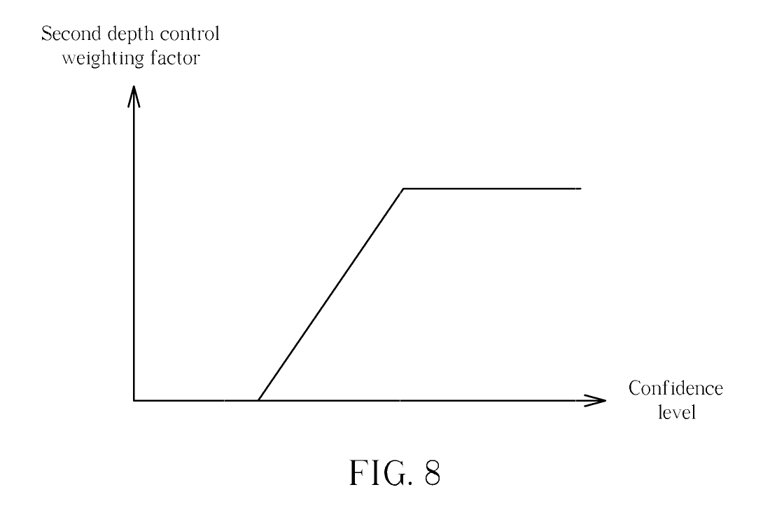

Regarding each of the second depth control weighting factors W_{L1}-W_{LN}, the depth control weighting factor may be positively correlated with the confidence level CL. For example, the depth control weighting factor would be set by a larger value when the confidence level CL is higher, and the depth control weighting factor would be set by a smaller value when the confidence level CL is lower. By way of example, but not limitation, the confidence level and the second depth control weighting factor (e.g., a local weighting factor) may bear the exemplary mapping relationship as shown in FIG. 8. It should be noted that the first depth control weighting factors W_{W1}-W_{WN} may be identical to or different from each other, and/or the second depth control weighting factors W_{L1}-W_{LN} may be identical to or different from each other, depending upon actual design requirement/consideration.

Each of the global depth-related value extractors 711_1-711_N is arranged for determining a global depth-related value (e.g., a global disparity/depth value) according to all depth-related values included in a corresponding depth-related information map. In other words, each of the depth-related information maps MAP₁-MAP_{N} would have one global depth-related value only. Therefore, the global depth-related value extractors 711_1-711_N generate global depth-related values D_{G1}-D_{GN}, respectively. Each of the local depth-related value extractors 712_1-712_N is arranged for determining a local depth-related value (e.g., a local disparity/depth value) for each depth-related value included in a corresponding depth-related information map according to the global depth-related value derived from the corresponding depth-related information map. In other words, each of the depth-related information maps MAP₁-MAP_{N} would have N local depth-related values if the number of depth-related values included in a depth-related information map is equal to N.

In one exemplary design, each global depth-related value extractor sets the global depth-related value by an average D_{AVG} of all depth-related values included in a corresponding depth-related information map. Specifically, the global depth-related value may be derived from the following equation.

$${D}_{AVG} = \frac{{\sum }_{i = 1}^{N} {D}_{i}}{N} \qquad ( 2 )$$

In above equation (2), Dᵢ is the i^{th} depth-related value included in an estimated depth-related information map (e.g., one of MAP₁-MAP_{N}), and N is the number of depth-related values included in the estimated depth-related information map (e.g., one of MAP₁-MAP_{N}).

In another exemplary design, each global depth-related value extractor sets the global depth-related value by a weighted sum D_{WS} of all depth-related values included in a corresponding depth-related information map, where a weighting factor of a first depth-related value is different from a weighting factor of a second depth-related value when the first depth-related value is different from the second depth-related value. Specifically, the global depth-related value may be derived from the following equation.

$${D}_{WS} = \frac{{\sum }_{i = 1}^{N} {W}_{i} \cdot {D}_{i}}{{\sum }_{i = 1}^{N} {W}_{i}} \qquad ( 3 )$$

In above equation (3), Dᵢ is the i^{th} depth-related value included in an estimated depth-related information map (e.g., one of MAP₁-MAP_{N}), N is the number of depth-related values included in the estimated depth-related information map (e.g., one of MAP₁-MAP_{N}), and

$${W}_{i} / {\sum }_{i = 1}^{N} {W}_{i}$$

is the weighting factor for the i^{th} depth-related value.

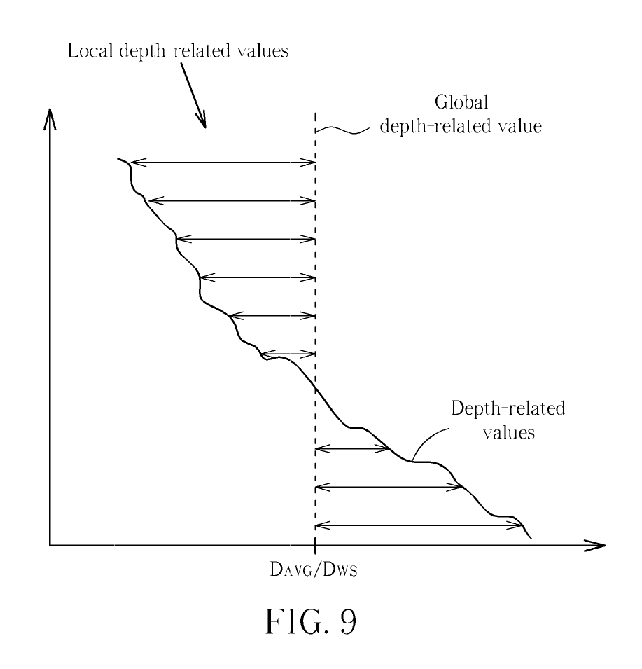

Regarding the derivation of the local depth-related values, each local depth-related value extractor in this embodiment may set the local depth-related value for each depth-related value included in the corresponding depth-related information map by subtracting the global depth-related value (e.g., D_{AVG} or D_{SW}) from the depth-related value, as shown in FIG. 9.

Please refer to FIG. 7 again. The adjustment value determinator 708 is coupled to the global depth-related value extractors 711_1-711_N and local depth-related value extractors 712_1-712_N, and includes a plurality of first multipliers 709_1-709_N, a plurality of second multipliers 710_1-710_N, and a plurality of adders 713_1-713_N. Each of the first multipliers 709_1-709_N is arranged for multiplying a corresponding first depth control weighting factor W_{G1}-W_{GN} and each global depth-related value (e.g., D_{AVG} or D_{SW}). Each of the second multipliers 710_1-710_N is arranged for multiplying a corresponding second depth control weighting factor W_{L1}-W_{LN} and the local depth-related values. Each of the adders 713_1-713_N performs an addition operation upon outputs of a preceding first multiplier and a preceding second multiplier to determine an adjustment value for a corresponding depth-related information map. In other words, the adjustment value determinator 708 in this embodiment is used to determine an adjustment value for each depth-related value.

Regarding the adjustment unit 704, it is coupled to the adjustment value determinator 708, and includes a plurality of adders 705_1-705_N, each arranged for performing a subtraction operation upon adjustment values and respective depth-related values to generate one adjusted depth-related information map having adjusted depth-related values included therein. In this way, the adjustment unit 704 outputs the adjusted depth-related information maps MAP₁′-MAP_{N}′ with the desired disparity/depth setting. The pixel-based operation of the adjustment circuit 700 may be expressed using the following equation.

D_{Adjusted}=D_{Estimated}α·D_{Local}−βD_{Global} (4)

In above equation (4), D_{Adjusted} represents an adjusted disparity/depth value included in an adjusted disparity/depth map, D_{Estimated} represents an original disparity/depth value included in an estimated disparity/depth map, α·D_{estimated} represents a local part of an adjustment value, β·D_{Global} represents a global part of the adjustment value, a represent a second depth control weighting factor, and β represents a first depth control weighting factor. It should be noted that the same second depth control weighting factor (i.e., the same local depth control weighting factor) is applied to all of the local depth-related values for the same depth-related information map, and the first depth control weighting factor (i.e., the global depth control weighting factor) is kept unchanged no matter whether the second depth control weighting factor is adjusted in response to the confidence level.

When there is a large occlusion region (or there are many occlusion regions) and/or the reliability of the estimated disparity/depth map is poor, the second depth control weighting factor would be reduced to mitigate the undesired side effect, thus allowing the 3D display to be adjusted to a comfortable convergence depth. In this way, the 3D display quality is improved.

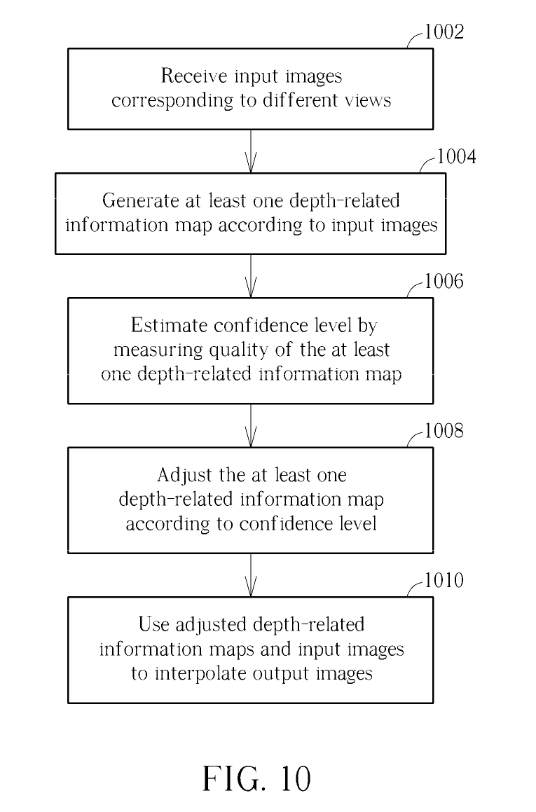

FIG. 10 is a flowchart illustrating a depth control method according to an embodiment of the present invention. If the result is substantially the same, the depth control method is not required to be executed in the exact order shown in FIG. 10. The exemplary depth control method may be employed by the device shown in FIG. 1, and may be briefly summarized by following steps.

Step 1002: Receive a plurality of input images corresponding to different views.

Step 1004: Generate at least one depth-related information map according to the input images.

Step 1006: Estimate a confidence level by measuring quality of the at least one depth-related information map.

Step 1008: Adjust the at least one depth-related information map according to the confidence level.

Step 1010: Use adjusted depth-related information maps and the input images to interpolate output images such that a depth effect of the output image is adaptively controlled in response to the adjusted depth-related information maps.

Steps 1002 and 1004 may be executed by the aforementioned depth-related information map generation circuit 102, step 1006 may be executed by the aforementioned quality measurement circuit 104, step 1008 may be executed by the aforementioned adjustment circuit 106, and step 1010 may be executed by the aforementioned image interpolation unit 101. As a person skilled in the art can readily understand details of each step after reading above paragraphs directed to the depth control apparatus 100, further description is omitted here for brevity.

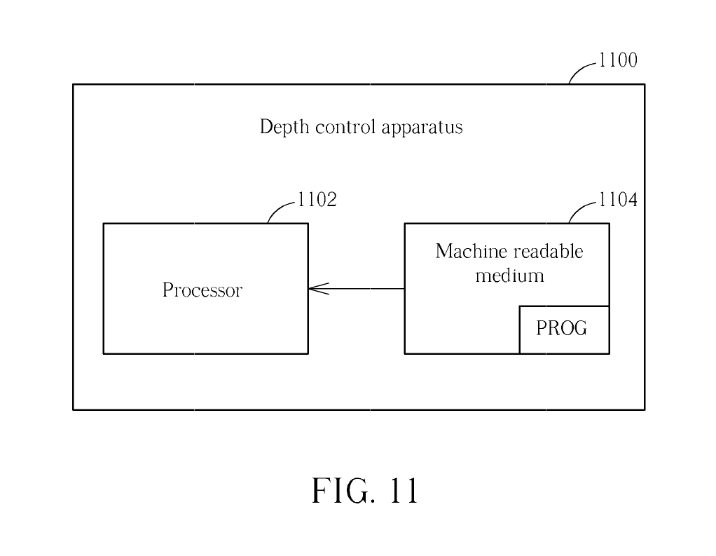

The depth control apparatus 100 employs a hardware-based solution to implement the adaptive depth adjustment feature. However, this is for illustrative purposes only, and is not meant to be a limitation of the present invention. In an alternative design, a software-based solution may be employed to implement the adaptive depth adjustment feature. Please refer to FIG. 11, which is a block diagram illustrating a depth control apparatus according to a second embodiment of the present invention. The depth control apparatus 1100 includes a processor (e.g., a micro control unit or a central processing unit) 1102 and a machine readable medium (e.g., a non-volatile memory) 1104. The machine readable medium 1104 is coupled to the processor 1102, and used to store a program code PROG such as firmware of the depth control apparatus 1100. When the program code PROG is loaded and executed by the processor 1102, the program code PROG causes the processor 1102 to perform steps shown in FIG. 10. The same objective of implementing the adaptive depth adjustment is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A depth control method, comprising:
receiving a plurality of input images corresponding to different views;
generating at least one depth-related information map according to the input images;
estimating a confidence level by measuring quality of the at least one depth-related information map; and
adjusting the at least one depth-related information map according to the confidence level.

2. The depth control method of claim 1, wherein the step of estimating the confidence level comprises:
performing a comparison upon images selected from the input images, and accordingly generating a comparison result; and
estimating the confidence level by referring to the comparison result.

3. The depth control method of claim 1, wherein the step of estimating the confidence level comprises:
generating at least one reconstructed image according to the at least one depth-related information map and at least one image selected from the input images;
performing a comparison upon the at least one reconstructed image and at least one image selected from the input images, and accordingly generating a comparison result; and
estimating the confidence level by referring to the comparison result.

4. The depth control method of claim 1, wherein the step of adjusting the at least one depth-related information map comprises:
determining an adjustment value for each depth-related value included in a depth-related information map according to the confidence level; and
applying adjustment values to respective depth-related values included in the depth-related information map.

5. The depth control method of claim 4, wherein the step of determining the adjustment value for each depth-related value comprises:
setting a depth control weighting factor in response to the confidence level; and
multiplying the depth control weighting factor and each depth-related value to determine the adjustment value for each depth-related value.

6. The depth control method of claim 5, wherein the depth control weighting factor is positively correlated with the confidence level.

7. The depth control method of claim 4, wherein the step of determining the adjustment value for each depth-related value comprises:
determining a global depth-related value according to all depth-related values included in the depth-related information map;
determining a local depth-related value for each depth-related value included in the depth-related information map according to the global depth-related value;
setting a first depth control weighting factor;
setting a second depth control weighting factor in response to the confidence level; and
multiplying the second depth control weighting factor and each local depth-related value and multiplying the first depth control weighting factor and the global depth-related value to determine the adjustment value for each depth-related value.

8. The depth control method of claim 7, wherein the step of determining the global depth-related value comprises:
setting the global depth-related value by an average of all depth-related values included in the depth-related information map.

9. The depth control method of claim 7, wherein the step of determining the global depth-related value comprises:
setting the global depth-related value by a weighted sum of all depth-related values included in the depth-related information map, wherein a weighting factor of a first depth-related value is different from a weighting factor of a second depth-related value when the first depth-related value is different from the second depth-related value.

10. The depth control method of claim 7, wherein the step of determining the local depth-related value for each depth-related value comprises:
setting the local depth-related value for each depth-related value by subtracting the global depth-related value from the depth-related value.

11. The depth control method of claim 7, wherein the second depth control weighting factor is positively correlated with the confidence level.

12. The depth control method of claim 7, wherein the first depth control weighting factor is kept unchanged each time determination of the adjustment value for each depth-related value is performed; or
the first depth control weighting factor and the second depth control weighting factor are adjusted separately.

13. A depth control apparatus, comprising:
a depth-related information map generation circuit, arranged for receiving a plurality of input images corresponding to different views, and generating at least one depth-related information map according to the input images;
a quality measurement circuit, arranged for estimating a confidence level by measuring quality of the at least one depth-related information map; and
an adjustment circuit, arranged for adjusting the at least one depth-related information map according to the confidence level.

14. The depth control apparatus of claim 13, wherein the quality measurement circuit comprises:
a comparison unit, arranged for performing a comparison upon images selected from the input images, and accordingly generating a comparison result; and
a quality estimation unit, arranged for estimating the confidence level by referring to the comparison result.

15. The depth control apparatus of claim 13, wherein the quality measurement circuit comprises:
a reconstruction unit, arranged for generating at least one reconstructed image according to the at least one depth-related information map and at least one image selected from the input images;
a comparison unit, arranged for performing a comparison upon the at least one reconstructed image and at least one image selected from the input images, and accordingly generating a comparison result; and
a quality estimation unit, arranged for estimating the confidence level by referring to the comparison result.

16. The depth control apparatus of claim 13, wherein the adjustment circuit comprises:
an adjustment value determination unit, arranged for determining an adjustment value for each depth-related value included in a depth-related information map according to the confidence level; and
an adjustment unit, arranged for applying adjustment values to respective depth-related values included in the depth-related information map.

17. The depth control apparatus of claim 16, wherein the adjustment value determination unit comprises:
a depth controller, arranged for setting a depth control weighting factor in response to the confidence level; and
an adjustment value determinator, arranged for multiplying the depth control weighting factor and each depth-related value to determine the adjustment value for each depth-related value.

18. The depth control apparatus of claim 17, wherein the depth control weighting factor is positively correlated with the confidence level.

19. The depth control apparatus of claim 16, wherein the adjustment value determination unit comprises:
a depth controller, arranged for setting a first depth control weighting factor, and for setting a second depth control weighting factor in response to the confidence level;
a global depth-related value extractor, arranged for determining a global depth-related value according to all depth-related values included in the depth-related information map;
a local depth-related value extractor, arranged for determining a local depth-related value for each depth-related value included in the depth-related information map according to the global depth-related value; and
an adjustment value determinator, arranged for multiplying the second depth control weighting factor and each local depth-related value and multiplying the first depth control weighting factor and the global depth-related value to determine the adjustment value for each depth-related value.

20. The depth control apparatus of claim 19, wherein the global depth-related value extractor sets the global depth-related value by an average of all depth-related values included in the depth-related information map.

21. The depth control apparatus of claim 19, wherein the global depth-related value extractor sets the global depth-related value by a weighted sum of all depth-related values included in the depth-related information map, where a weighting factor of a first depth-related value is different from a weighting factor of a second depth-related value when the first depth-related value is different from the second depth-related value.

22. The depth control apparatus of claim 19, wherein the local depth-related value extractor sets the local depth-related value for each depth-related value by subtracting the global depth-related value from the depth-related value.

23. The depth control apparatus of claim 19, wherein the second depth control weighting factor is positively correlated with the confidence level.

24. The depth control apparatus of claim 19, wherein the first depth control weighting factor is kept unchanged each time determination of the adjustment value for each depth-related value is performed; or
the first depth control weighting factor and the second depth control weighting factor are adjusted separately.

25. A nonstatutory machine readable medium, storing a program code which causes a processor to perform following steps when executed by the processor:
receiving a plurality of input images corresponding to different views;
generating at least one depth-related information map according to the input images;
estimating a confidence level by measuring quality of the at least one depth-related information map; and
adjusting the at least one depth-related information map according to the confidence level.
